(19) United States
(12) Patent Application Publication
(10) Pub. No.: US 2026/0185634 A1
(43) Pub. Date: Jul. 2, 2026

(54) METHOD AND SYSTEM FOR PREPARING SUBSEA EQUIPMENT FOR USE WITH DIVERLESS INSTALLATION MEANS

(71) Applicant: PETROLEO BRASILEIRO S.A. - PETROBRAS, Rio de Janeiro (BR)

(72) Inventors: Samuell Costa DE SOUZA, Macae (BR); Nelio Pereira COUTINHO, Macae (BR)

(21) Appl. No.: 19/428,863

(22) Filed: Dec. 22, 2025

(30) Foreign Application Priority Data
Dec. 27, 2024 (BR) 1020240274822

(51) Int. Cl. F16L 1/26; F16L 1/20

(52) U.S. Cl. CPC F16L 1/26; F16L 1/207

(57) ABSTRACT

The present invention discloses a method and system for preparing subsea equipment (2) for use with DIVERLESS installation means. The aforementioned method comprises the steps of: positioning a bushing (1) in the respective holes of the subsea equipment (2) on a first side, where the bushing (1) includes a flange and a cylindrical body; locking nuts (4) on a first end of the respective studs (3); inserting, from a second side, a second end of the studs (3) into the respective holes; and threading the second end of the studs (3) into the respective bushings (1) already positioned in the respective holes of the subsea equipment (2). The mentioned system comprises a plurality of bushings (1) made up of a flange and a cylindrical body, a plurality of studs (3), and a plurality of nuts (4), these elements being used to prepare subsea equipment to be used with DIVERLESS installation means.

### CROSS-REFERENCE TO RELATED APPLICATIONS

This application claims priority to Brazilian Application No. BR 1020240274822, filed on Dec. 27, 2024; the disclosure of which is incorporated herein by reference.

### FIELD OF THE INVENTION

The present invention falls within the field of techniques and technologies for the preparation, recovery, or recommissioning of subsea equipment. More specifically, the present invention relates to a method and system for preparing subsea equipment for use with diverless installation means.

### BACKGROUND OF THE INVENTION

There is a growing demand for diverless operations, that is, carried out only by remotely operated vehicles (ROV), for the installation of pull heads, CB, for retrieval of flexible pipes by PLSV vessels and/or for the installation of blind flanges for temporary abandonment of the pipes.

Currently, the pull heads and blind flanges for these operations, more specifically pull heads and blind flanges that follow API standards, as illustrated in FIG. 1, need to be prepared by performing mechanical surface treatment and welding the nuts onto the existing holes in them. Said welding of the nuts into the existing holes is necessary to allow the installation (or pre-installation) of studs in the respective holes. Next, after positioning the API flanges in the desired location, the ROV can complete the torquing of the connection using its own tools, such as, for example, screwdrivers and torque wrenches.

In general, the current sequence of activities for the preparation of the pull head and/or blind flange includes:
shipping logistics of materials from vessels and/or Petrobras stocks to carry out the preparation/adaptation process on land, as illustrated in FIG. 1;
machining team to prepare nuts (approximately 2.0 mm recess on one end of the nut) for subsequent welding onto the pull head/blind flange, as illustrated in FIG. 2.

The preparation/machining of the nuts aims to ensure that they are centered on the existing holes in the flanges during the welding process;
boilermaking team to prepare the installation area, as illustrated in FIG. 3, as well as the positioning and welding of the centered nuts with the drilling of the flanges using the recess made in the previous step, and next, perform the intermittent welding of the nuts and, optionally, weld an eyebolt and handles for handling by the ROV, as illustrated in FIG. 4.
painting team for the treatment of the flange and nuts after the adaptation process of the CBs/blind flanges, as illustrated in FIG. 5; and
logistics of shipping materials to the vessels.

Thus, the aforementioned preparation enables the operation of installing a pull head and/or blind flanges to be carried out in a diverless manner. However, due to mechanical treatment operations and welding, the pull head loses its API qualification/certification for pipe hoisting. Consequently, the lines are collected with traction heads that do not meet the API standard.

Additionally, there is no nut material standard that indicates the use of welding for applications in submarine environments, as the mentioned operation alters the microstructure of the material, affecting its structural integrity.

In this sense, it will also be appreciated that the aforementioned preparation requires a large number of resources and materials, such as:
availability of a large quantity of pull heads, studs, and nuts;
machining and welding teams for the fabrication of jigs and the welding of nuts;
painting team to paint the nuts after the welding process and mechanical treatment of the CT; and
logistics of shipping materials to the vessels.

Therefore, there is a need for a pull head and/or blind flange preparation solution that maintains the integrity of the pull head and complies with the API standard by not using welding in the process of securing the nuts. Additionally, there is a need for a solution for preparing the pull head and/or blind flange for flexible installation, whether on the vessel or onshore, which optimizes the time and cost of said operation.

### STATE OF THE ART

In the state of the art, there are some documents focused on devices for the preparation and/or adaptation of holes for connection between elements.

Document U.S. Pat. No. 2,632,355 discloses a threaded nut with a flange that is adapted to engage a bolt arranged through a wooden panel, metal sheet, or similar. The referred coupling flange on the construction support panel is enhanced by means of corrugations, so that it is capable of withstanding high stresses without substantial deformation.

Document US20090136320 discloses a connector with an internal thread. The internally threaded connector device is a thin-walled internally threaded tube. A relatively short section of the device includes a polygonal key gripping flange area.

Document U.S. Pat. No. 8,267,630 discloses a fastening system that includes a first material having a first hole, a second material having a second hole, a bushing, and a threaded bolt. The bushing is located in the second hole and has one end resting against the first material and a flanged second end to secure the bushing to the second material. A threaded bolt extends through the first hole and into the bushing to fasten the first material flush with the second material.

In view of the of the state of the art disclosure, the characteristics and advantages of this invention will clearly emerge from the detailed description below and with reference to the attached drawings.

### BRIEF DESCRIPTION OF THE INVENTION

The present invention discloses a method and system for preparing subsea equipment (2) for use with diverless installation means. The aforementioned method comprises the steps of: positioning a bushing (1) in the respective holes of the subsea equipment (2) on a first side, where the bushing (1) includes a flange and a cylindrical body; locking nuts (4) on a first end of the respective studs (3); inserting, from a second side, a second end of the studs (3) into the respective holes; and threading the second end of the studs (3) into the respective bushings (1) already positioned in the respective holes of the subsea equipment (2). The mentioned system comprises a plurality of bushings (1) made up of a flange and a cylindrical body, a plurality of studs (3), and a plurality of nuts (4), these elements being used to prepare subsea equipment to be used with diverless installation means.

### BRIEF DESCRIPTION OF THE FIGURES

To complement the present description and gain a better understanding of the features of this invention, a set of figures is presented, where, in an illustrative but non-limiting manner, preferred embodiments of the invention are represented.

FIG. 1 illustrates the logistics of sending the pull head/blind flange to perform the adaptation process onshore.

FIG. 2 illustrates the preparation/machining of the nuts to enable their centralization for subsequent welding.

FIG. 3 illustrates the preparation of an installation area of the nuts by a boilermaking team.

FIG. 4 illustrates the welding of nuts centered with the flange holes, and the optional welding of an eyebolt and handling handles for the ROV.

FIG. 5 illustrates the treatment of the flange and nuts by a painting team.

FIG. 6 illustrates a pull head/blind flange prepared/assembled according to the present invention.

FIG. 7A illustrates a top view of a pull head/blind flange prepared/mounted in accordance with the present invention.

FIG. 7B illustrates a corresponding cross-sectional cut of a pull head/blind flange prepared/mounted in accordance with the present invention.

FIG. 8 illustrates an enlargement of the accommodation details of the bushing in a recess on the pull head/blind flange.

FIG. 9 illustrates a perspective view of the preferred configuration of the bushing with a hexagon-shaped flange.

FIG. 10A illustrates a top view of the hexagonal bushing.

FIG. 10B illustrates a corresponding cross-sectional cut of the hexagonal bushing.

FIG. 11A illustrates a top view of another preferred configuration of the bushing, with a circular-shaped flange featuring a cut. The referred cut acts as a stop to prevent the bushing from rotating.

FIG. 11B illustrates a corresponding cross-sectional cut of another preferred configuration of the bushing, with a circular-shaped flange featuring a cut. The referred cut acts as a stop to prevent the bushing from rotating.

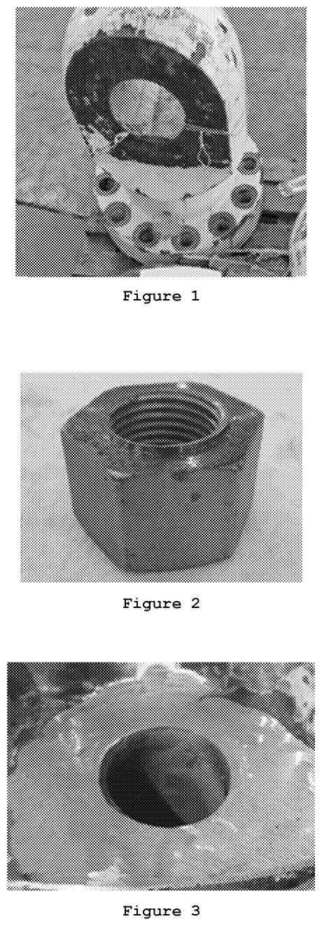

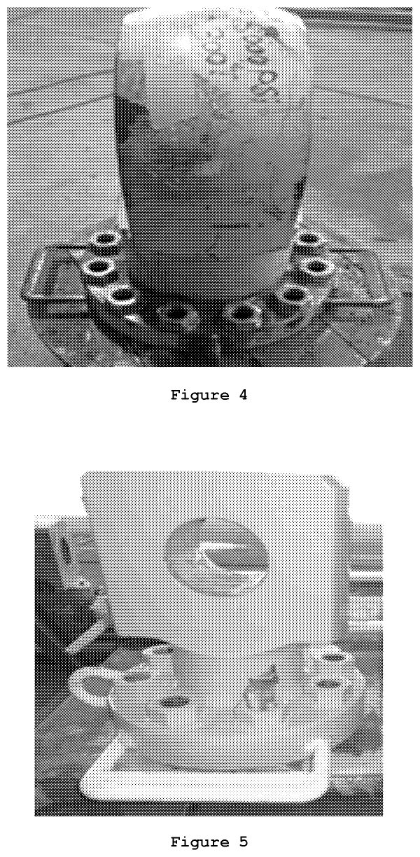

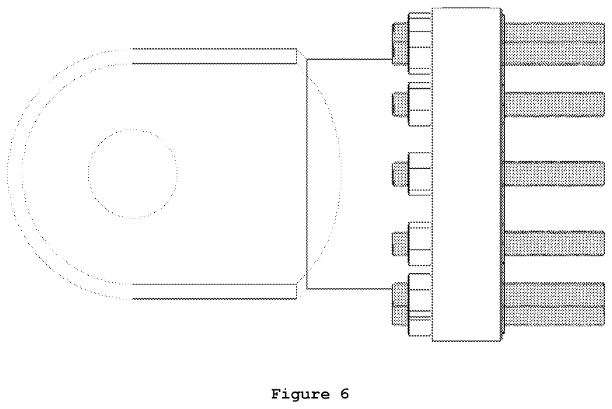

### DETAILED DESCRIPTION OF THE INVENTION

The present invention relates to a method and system for preparing a subsea equipment (2) for use with diverless installation means, having particular application in diverless intervention for the installation of subsea equipment such as pull heads and blind flanges.

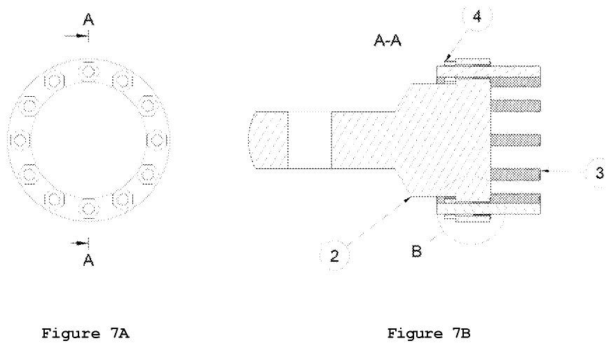

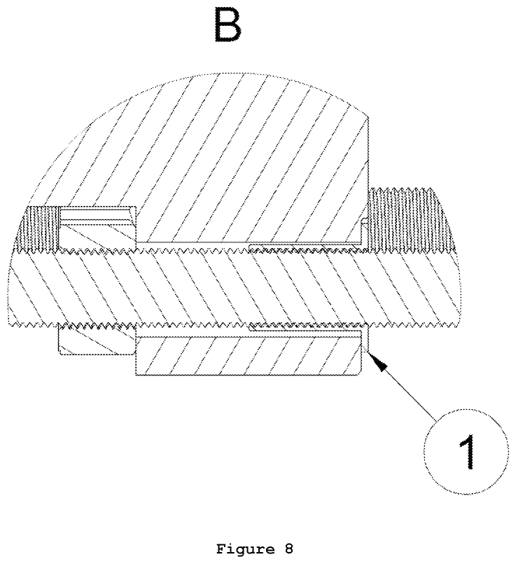

In general, and as illustrated in FIGS. 6 to 8, the invention involves the use of a bushing (1) that allows the installation of studs (3) and nuts (4) on subsea equipment (2) without the need for surface preparation or welding, thereby maintaining the qualification/certification, such as API certification, of said equipment. Furthermore, the aforementioned bushing (2) holds the studs (3) and nuts (4) in a subsea equipment (2) so that it can be positioned and then installed using diverless installation means, such as through a ROV. Thus, the aim is to reduce logistics and preparation costs, as well as to meet the requirements of the API standard.

It will be appreciated that the present invention can be designed to be used with various sizes of subsea equipment and their respective pressure classes, depending on the context of use. For example, the invention can be designed for pull heads and/or API flanges with dimensions of 2 9/16″, 4 1/16″, 7 1/16″, 9″, or 11″, in pressure classes of 5,000 psi and 10,000 psi.

In this context, and without limitation, some advantages of the present invention compared to the state are:
enable the installation of nuts and/or studs centrally on the pull head and blind flanges without the need for treatment, welding, or sending this subsea equipment to an onshore base;
ensure the integrity of the pull head and blind flanges, thus complying with the API standard, as no welding is used in the process of fastening the nuts;
greater resource flexibility since the materials could be sent directly to the support vessels specialized in remote operations, such as RSVs, during their stay at the ports or received directly from vessels designated to deploy and retrieve lines, such as PLSVs. The aforementioned materials can also be abandoned on the seabed or transshipped to RSV or platforms;
keep on the vessels, sets of the present invention to enable their installation by the onboard teams.
very low installation time, significant reduction of health, environment, and safety (HES) risks since it does not involve hot work and painting; and
low cost of manufacturing and installation on pull heads or blind flanges.

According to a preferred embodiment of the present invention, a method/process for preparing subsea equipment (2) for use with diverless installation means is disclosed. The referred method comprises at least the steps of:
a) positioning a bushing (1) in the respective holes of the subsea equipment (2) on a first side, where the bushing (1) includes a flange and a cylindrical body;
b) locking nuts (4) on a first end of the respective studs (3);
c) inserting, from a second side, a second end of the studs (3) into the respective holes; and
d) threading the second end of the studs (3) into the respective bushings (1) already positioned in the respective holes of the subsea equipment (2).

Wherein the method, in step a), of accommodating the bushing (1), may further include positioning it in a recess on the first side of the subsea equipment (2). The aforementioned recess, or groove, is preferably a recess designed for the installation of a ring joint. The aforementioned ring joint can be a BX ring commonly used in the oil and gas industry for flanges, pull heads, pipelines, valves, and pressure vessels in refineries, petrochemical industries, wellhead and drilling equipment, Christmas tree valves, and lines.

It will be appreciated that the step of fitting the bushing (1) into the respective holes of the subsea equipment (2) can be carried out without the use of specialized tools. Furthermore, the step of threading d) the second end of the studs (3) onto the respective bushings (1) may involve the use of a manual wrench.

Moreover, preferably in which, on the first side, the flange of the bushing (2) is positioned on the side of a connector of a flexible pipe.

The aforementioned bushing (1) is a bushing for API flanges preferably made from either polypropylene, brass, or bronze.

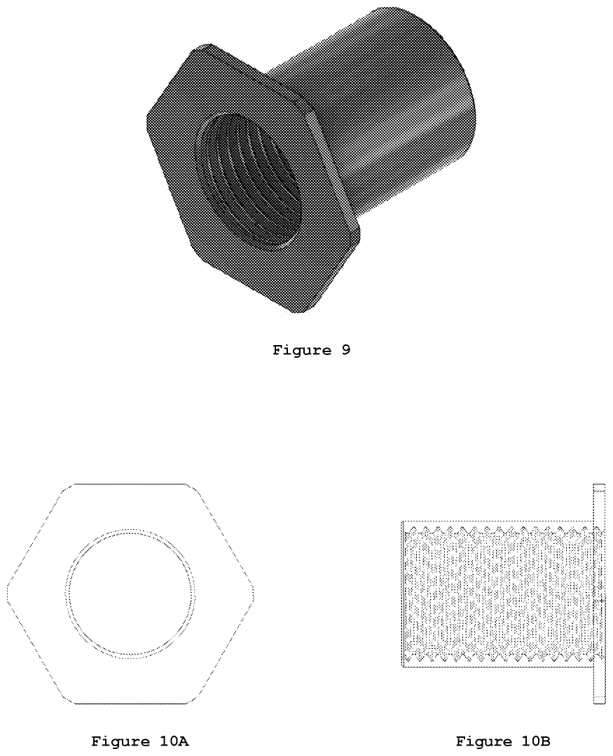

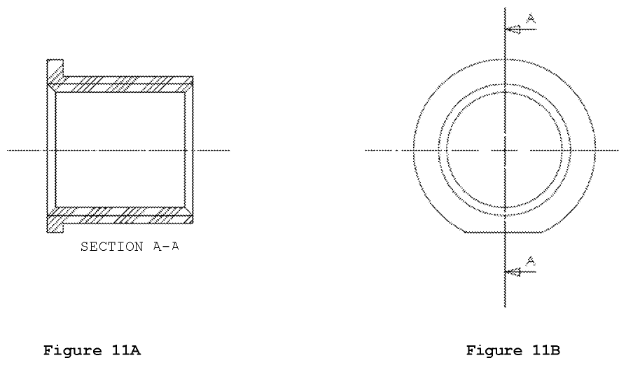

As illustrated in greater detail in FIG. 9 and FIGS. 10A and 10B, said flange of the bushing (1) may have a hexagon-shaped perimeter. Alternatively, and as illustrated in FIGS. 11A and 11B, the aforementioned flange of the bushing (1) may comprise a circular circumference with a cut. The mentioned cut is preferably a circular segment or a disk segment, resulting in a flange with the shape of a circular arc with a chord connecting its endpoints.

The aforementioned cylindrical body of the bushing (1) preferably consists of a smooth outer part and a threaded inner part along the entire length of the bushing (1), so that the threaded part is found both in the body and in the flange of the bushing (1).

It will be appreciated that the method may optionally further comprise a step of welding an eyebolt and handling handles on the subsea equipment (2).

According to another preferred embodiment of the present invention, a system for preparing subsea equipment (2) for use with diverless installation means is disclosed. The mentioned system comprises:
a plurality of bushings (1) made up of a flange and a cylindrical body;
a plurality of studs (3), and
a plurality of nuts (4),
in which the bushings (1) are accommodated in respective holes of the subsea equipment (2) on a first side,
in which the nuts (4) are locked at a first end of the respective studs (3); and
in which a second end of the studs (3) is inserted into a second side of the respective holes of the subsea equipment and screwed into the respective bushings (1) already accommodated in the respective holes.

The first side of the subsea equipment (2) preferably comprises a recess to accommodate the bushing (1). The aforementioned recess, or groove, is preferably a recess designed for the installation of a ring joint. The aforementioned ring joint can be a BX ring commonly used in the oil and gas industry for flanges, pull heads, pipelines, valves, and pressure vessels in refineries, petrochemical industries, wellhead and drilling equipment, Christmas tree valves, and lines.

It will be appreciated that fitting the bushing (1) into the respective holes of the subsea equipment (2) can be carried out without the use of specialized tools. Furthermore, threading the second end of the studs (3) onto the respective bushings (1) may involve the use of a manual wrench.

Moreover, preferably in which, on the first side, the flange of the bushing (2) is positioned on the side of a connector of a flexible pipe.

The aforementioned bushing (1) is a bushing for API flanges preferably made from either polypropylene, brass, or bronze.

As illustrated in greater detail in FIG. 9 and FIGS. 10A and 10B, said flange of the bushing (1) may have a hexagon-shaped perimeter. Alternatively, and as illustrated in FIGS. 11A and 11B, the aforementioned flange of the bushing (1) may comprise a circular circumference with a cut. The mentioned cut is preferably a circular segment or a disk segment, resulting in a flange with the shape of a circular arc with a chord connecting its endpoints.

The aforementioned cylindrical body of the bushing (1) preferably consists of a smooth outer part and a threaded inner part along the entire length of the bushing (1), so that the threaded part is found both in the body and in the flange of the bushing (1).

Thus, the skilled in the art will value the knowledge presented herein and will be able to carry out the invention described in the presented embodiment and their variants covered in the scope of the claims below.

The invention discloses a method and system for preparing subsea equipment (2) for use with DIVERLESS installation means. The aforementioned method comprises the steps of: positioning a bushing (1) in the respective holes of the subsea equipment (2) on a first side, where the bushing (1) includes a flange and a cylindrical body; locking nuts (4) on a first end of the respective studs (3); inserting, from a second side, a second end of the studs (3) into the respective holes; and threading the second end of the studs (3) into the respective bushings (1) already positioned in the respective holes of the subsea equipment (2). The mentioned system comprises a plurality of bushings (1) made up of a flange and a cylindrical body, a plurality of studs (3), and a plurality of nuts (4), these elements being used to prepare subsea equipment to be used with DIVERLESS installation means.

1. A method for preparing subsea equipment (2) with diverless installation, comprising:
a) positioning a bushing (1) in the respective holes of the subsea equipment (2) on a first side, wherein the bushing (1) includes a flange and a cylindrical body;
b) locking nuts (4) on a first end of respective studs (3);
c) inserting, from a second side, a second end of the studs (3) into the respective holes of the subsea equipment (2); and
d) threading the second end of the studs (3) into the respective bushings (1) already positioned in the respective holes of the subsea equipment (2).

2. The method according to claim 1, further comprising:
accommodating the bushing (1) and positioning the bushing (1) in a recess on the first side of the subsea equipment (2).

3. The method according to claim 1, further comprising:
screwing the second end of the studs (3) into the respective bushings (1) with a manual wrench.

4. The method according to claim 1, wherein the flange of the bushing (1) comprises a perimeter or circumference in a hexagonal or circular shape with a cut.

5. The method according to claim 1, wherein the cylindrical body of the bushing (1) consists of a smooth outer part and a threaded inner part along the entire length of the bushing (1).

6. The method according to claim 1, further comprising:
optionally, welding an eyebolt and handles for handling.

7. A system for preparing subsea equipment (2) with diverless installation, comprising:
a plurality of bushings (1) each comprising a flange and a cylindrical body;
a plurality of studs (3), and
a plurality of nuts (4),
wherein each of the plurality of bushings (1) are accommodated in respective holes of the subsea equipment (2) on a first side,
wherein each of the plurality of nuts (4) are locked at a first end of the respective plurality of studs (3); and
wherein a second end of each of the plurality of studs (3) is inserted into a second side of the respective holes of the subsea equipment (2) and screwed into the respective plurality of bushings (1) already accommodated in the respective holes of the subsea equipment (2).

8. The system, according to claim 7, wherein the first side of the subsea equipment (2) comprises a recess to accommodate each of plurality of bushings (1).

9. The system, according to claim 7, wherein the second end of each of the plurality of studs (3) is screwed into the respective plurality of bushings (1) with a manual wrench.

10. The system, according to claim 7, wherein the flange of each of the plurality of bushings (1) comprises a perimeter or circumference in a hexagonal or circular shape with a cut.

11. The system, according to claim 7, wherein the cylindrical body of each of the plurality of bushings (1) consists of a smooth outer part and a threaded inner part along the entire length of the plurality of bushings (1).

12. The system, according to claim 7, wherein each of the plurality of bushings (1) is a bushing for API flanges and is made from any of the following materials: polypropylene, brass, or bronze.
